(19) United States
(12) Patent Application Publication
(10) Pub. No.: US 2017/0068720 A1
(43) Pub. Date: Mar. 9, 2017

(54) SYSTEMS AND METHODS FOR CLASSIFYING DATA QUERIES BASED ON RESPONSIVE DATA SETS

(71) Applicant: Google Inc., Mountain View, CA (US)

(72) Inventors: Jeongwoo Ko, Irvine, CA (US); Frank Uyeda, San Diego, CA (US); Arturo Ruiz, II, Tustin, CA (US); Bozhena Bidyuk, Huntington Beach, CA (US)

(21) Appl. No.: 14/846,369

(22) Filed: Sep. 4, 2015

(51) Int. Cl. G06F 17/30

(52) U.S. Cl. CPC G06F 17/30598; G06F 17/30528; G06F 17/30867

(57) ABSTRACT

An analytics engine for determining analytic relationships in data queries based on responsive data sets includes a memory for storing data and a processor in communication with the memory. The processor is configured to identify a data query for analysis from a query repository, retrieve a plurality of interaction data associated with the data query, wherein the interaction data represents interactions between a plurality of user systems and a query result previously generated based on the data query, wherein the query result includes a plurality of links, identify a link selection count for each of the plurality of links based on the plurality of interaction data, classify the data query as one of a content targeting query and a data-creator targeting query based upon the plurality of link selection counts, and generate a query characteristic analysis based upon the classified data query and the plurality of link selection counts.

### BACKGROUND

This description relates to information queries, and more particularly, to methods and systems for determining characteristics of data queries based on responsive data sets.

At least some online information (e.g., web sites) may be identified using data queries such as search queries. Systems may transmit a data query, typically comprised of query terms, to a query engine (such as a search engine). The query engine may then provide the systems with a set of results (“query results”). The query results indicate data (such as online publications) that is responsive to the data query. The query results also include methods of accessing such data (e.g., including online publications) via links such as web links. The systems may then access the data such as online publications via the web links.

In many examples, the structure and nature of data queries may vary. In a first example, data queries may be designed to identify a particular creator of data such as a publisher of online publications. The querying system may transmit the data query with information that directly identifies a data creator. Such identifying information may include a domain name associated with the data creator or a descriptive name typically associated with the data creator. In such examples, the querying system will typically select data from the particular data creator in the query results. This first example of data queries may be identified as “creator targeting data queries.”

Alternately, in a second example, data queries may be designed to identify classes of information that may be included within data from a variety of different data creators. The querying system may transmit the data query with information that identifies the class of information. For example, such identifying information may describe products, services, or other attributes associated with multiple data creators. This second example of data queries may be identified as “content targeting data queries.”

Query engines and related systems may benefit from being able to distinguish between the two described types of data queries. For example, it may be beneficial to determine when a data query seeks to directly identify a data creator as opposed to when a data query seeks to directly identify classes of information that may be included within data from a variety of data creators. Distinguishing data queries in this manner may allow for improved organization of query results and, in the case of creator targeting data queries, may also provide improved interaction between the query engine and the data creators.

### BRIEF DESCRIPTION OF THE DISCLOSURE

In one aspect, a computer-implemented method for determining analytic relationships in data queries based on responsive data sets is provided. The method is implemented by an analytics engine coupled to a memory device. The method includes identifying a data query for analysis from a query repository, retrieving a plurality of interaction data associated with the data query, wherein the interaction data represents interactions between a plurality of user systems and a query result previously generated based on the data query, wherein the query result includes a plurality of links, identifying a link selection count for each of the plurality of links based on the plurality of interaction data, classifying the data query as one of a content targeting query and a data-creator targeting query based upon the plurality of link selection counts, and generating a query characteristic analysis based upon the classified data query and the plurality of link selection counts.

In another aspect, an analytics engine for determining analytic relationships in data queries based on responsive data sets is provided. The analytics engine includes a memory for storing data and a processor in communication with the memory. The processor is configured to identify a data query for analysis from a query repository, retrieve a plurality of interaction data associated with the data query, wherein the interaction data represents interactions between a plurality of user systems and a query result previously generated based on the data query, wherein the query result includes a plurality of links, identify a link selection count for each of the plurality of links based on the plurality of interaction data, classify the data query as one of a content targeting query and a data-creator targeting query based upon the plurality of link selection counts, and generate a query characteristic analysis based upon the classified data query and the plurality of link selection counts.

In another aspect, a computer-readable storage device having processor-executable instructions embodied thereon, for determining analytic relationships in data queries based on responsive data sets is provided. When executed by a computing device, the processor-executable instructions cause the computing device to identify a data query for analysis from a query repository, retrieve a plurality of interaction data associated with the data query, wherein the interaction data represents interactions between a plurality of user systems and a query result previously generated based on the data query, wherein the query result includes a plurality of links, identify a link selection count for each of the plurality of links based on the plurality of interaction data, classify the data query as one of a content targeting query and a data-creator targeting query based upon the plurality of link selection counts, and generate a query characteristic analysis based upon the classified data query and the plurality of link selection counts.

In another aspect, a system for determining analytic relationships in data queries based on responsive data sets is provided. The system includes means for identifying a data query for analysis from a query repository, means for retrieving a plurality of interaction data associated with the data query, wherein the interaction data represents interactions between a plurality of user systems and a query result previously generated based on the data query, wherein the query result includes a plurality of links, means for identifying a link selection count for each of the plurality of links based on the plurality of interaction data, means for classifying the data query as one of a content targeting query and a data-creator targeting query based upon the plurality of link selection counts, and means for generating a query characteristic analysis based upon the classified data query and the plurality of link selection counts.

In another aspect, the system described above is provided, wherein the system further includes means for retrieving the plurality of interaction data from at least one of a data-creator system, a query engine, and a query analytics system.

In another aspect, the system described above is provided, wherein the system further includes means for identifying a link selection frequency based on the plurality of interaction data, and means for classifying the data query based upon the link selection count and the link selection frequency.

In another aspect, the system described above is provided, wherein the system further includes means for identifying a minimum interaction frequency threshold, and means for identifying the link selection count based on the plurality of interaction data for the interaction data that satisfies the minimum interaction frequency threshold.

In another aspect, the system described above is provided, wherein the system further includes means for identifying a minimum link selection count threshold, and means for classifying the data query based upon the link selection count and the minimum link selection count threshold.

In another aspect, the system described above is provided, wherein the system further includes means for providing a data-creator system with a traffic pattern analysis based upon the classified data query.

In another aspect, the system described above is provided, wherein the system further includes means for reporting on data query performance based upon the classified data query.

In another aspect, the system described above is provided, wherein the system further includes means for adapting the query result for the data query based upon the data query classification.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a diagram depicting an example online data environment;

FIG. 2 is a block diagram of a computing device, used for determining analytic relationships in data queries based on responsive data sets, as shown in the online data environment of FIG. 1;

FIG. 3 is an example data flowchart of determining analytic relationships in data queries based on responsive data sets using the computing device of FIG. 2 in the online data environment shown in FIG. 1;

FIG. 4 is an example method of determining analytic relationships in data queries based on responsive data sets using the online data environment of FIG. 1; and

FIG. 5 is a diagram of components of one or more example computing devices, for determining analytic relationships in data queries based on responsive data sets using the online data environment that may be used in the environment shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description refers to the accompanying drawings. The same reference numbers in different drawings may identify the same or similar elements. Also, the following detailed description is not intended to limit the scope of the claims.

The subject matter described herein relates generally to information queries, and more particularly, to methods and systems for determining characteristics of data queries based on responsive data sets.

As described above, determining analytic relationships in data queries based on responsive data sets may allow for improved organization of query results and, in the case of creator targeting data queries, may also provide improved interaction between the query engine and the data creators. Accordingly, systems and methods of determining analytic relationships in data queries, such as those described below, may be of interest.

As used herein, “analytic relationship” refers to the relationship between a data query and data identified by the data query. In some embodiments, analytic relationships include, but are not limited to, distinguishing between whether a data query may be classified as a “content targeting query” or a “data-creator targeting query”. Alternatively, analytic relationships may identify other patterns of relationships between data queries and data.

As used herein, “data queries” refer to queries that may be used to identify data. In at least some examples, data queries may represent terms (e.g., search terms) used to identify content such as online publication content. In many examples, data queries may be represented by one or more strings of alpha-numeric text including alpha-numeric terms or words. In other examples, data queries may also include voice, image, or video queries. Accordingly, data queries may represent search queries that are used to identify content in electronic resources including online resources.

As used herein, “query results” refer to responsive results that may include data identifiers and data links produced by query processing engine (such as a search engine). In many examples, query results accordingly include one or more links to associated data that may be used to allow access to data associated with one or more data-creators.

As used herein, “data-creator” represents an entity responsible for the generation of a particular piece of data. Further, in the context of the analytic relationships described, “data-creator targeting queries” are data queries that are directed towards finding data associated with a particular data-creator. In at least some examples, such data-creator queries may accordingly include information related to the data-creator including a name or variation associated with the data-creator. In other examples, such data-creator queries may include information identifying a secondary identifier associated with a data-creator. In some examples, the “data-creator” may also be referred to as a publisher.

As used herein, “content targeting queries” represent data queries that are directed to finding data that is not associated with a particular data-creator. Rather, content targeting queries are data queries that identify only publications having content that is related to a particular content targeting query and may therefore have a plurality of different data-creators (or publishers).

The systems described herein utilize an analytics engine in communication with a plurality of user systems. In some embodiments, the analytics engine is also in communication with a plurality of data-creator systems (including, but not limited to, publisher systems) and a plurality of query engine systems (including, but not limited to, a search engine system). The analytics engine may also be in communication with a secondary query analytics data repository. Further, as described herein, the described systems may be in communication with one another generally. As such, the user systems may interact with the data-creator systems (including publisher systems) and the query engine systems (including search engine systems). As described below, the systems and methods described herein are configured to determine analytic relationships in data queries based on responsive data sets and, more specifically, to classify data queries as one of a content targeting query and a data-creator targeting query based upon the link selection counts associated with the data query.

In the example system, interactions between user systems and query results (provided by query engines based on data queries) are analyzed by the analytics engine. As described above and below, the analytics engine identifies data queries for analysis. Further, the analytics engine also receives interaction data from one of several systems. The interaction data defines interactions made between the user systems and the query results. In the example embodiment, the interaction data defines the selections made by user systems web links (or other methods of access) provided in the query results. Accordingly, the analytics engine identifies selections made by user systems for particular data provided in query results for each data query.

Further, the analytics engine analyzes the interaction data to determine the distribution of interactions made by the user systems with respect to the query results. For example, the query engine may identify the number of distinct links (“link selection count”) that are accessed by user systems for each data-creator displayed in a query result for a particular data query. Further, the analytics engine may identify the frequency of selection of each of the distinct links (“link selection frequency”) accessed by the user systems. As described, “data-creator targeting queries” primarily receive interaction with links for the particular data-creator (or the particular publisher). Alternately, “content targeting data queries” receive interactions with a variety of data-creators (because no particular data-creator is targeted). Based on the link selection count and the link selection frequency, the analytics engine determines whether the data query is a “data-creator targeting search query” or a “content targeting data query.”

In the example embodiment, the determination of whether the data query is a “data-creator targeting query” or a “content targeting data query” may be facilitated by two thresholds. The first threshold (a “minimum interaction frequency threshold”) specifies a minimum number of link selections that may be required for a distinct link to be included in the link selection count. Because some interactions may be made in error, the analytics engine may only identify link selections as applying to the link selection count when this minimum interaction frequency threshold is met. The second threshold (a “minimum link selection count threshold”) species a minimum number of distinct link selections that may be required for a data query to be classified as a “content targeting data query.”

In some examples, the data queries may be created based upon variations of the name of a particular data-creator (or targeted data-creator). For example, the domain name for a data-creator may be “EntityA.com” but targeted data queries for this data-creator may include alternate forms and misspellings such as “EntityAA.com” and “EntityA.” In at least some examples, the analytics engine may be configured to identify that such query terms relate to the targeted data-creators using techniques such as natural language processing or other data classifications. Further, associated search queries for such variant and misspelling forms may be analyzed in conjunction with a standard data query.

In the example system, an analytics engine computing device is configured to: (i) identify a data query for analysis from a query repository, (ii) retrieve a plurality of interaction data associated with the data query, wherein the interaction data represents interactions between a plurality of user systems and a query result previously generated based on the data query, wherein the query result includes a plurality of links, (iii) identify a link selection count for each of the plurality of links based on the plurality of interaction data, (iv) classify the data query as one of a content targeting query and a data-creator targeting query based upon the plurality of link selection counts, and (v) generate a query characteristic analysis based upon the classified data query and the plurality of link selection counts.

The analytics engine is configured to identify data queries (such as search queries) for analysis from a query repository. The query repository may be generated on demand, identified manually, or previously generated based upon analysis of data queries captured by the systems described above including the analytics engine, the data-creator systems, and the query engine systems. In many examples, the analytics engine may process multiple data queries simultaneously and therefore classify multiple data queries simultaneously.

The analytics engine is also configured to retrieve a plurality of interaction data associated with the identified data query. The interaction data represents interactions between a plurality of user systems and a query result previously generated based on the data query. The query result includes a plurality of links and may also include descriptive information describing the data available based upon a selection of a link.

As described below, the interaction data may be provided in a variety of formats. In a first example, the interaction data is provided by the data-creator or publisher. For example, the data-creator may collect directly, or through an intermediary, interaction data generated by user systems accessing their data (e.g., visiting a website associated with the data-creator). In one example, the collected interaction data may include information that is passed as part of the request URL to fetch the data. For example, a query engine (e.g., a search engine) may produce query results with a plurality of data links such that each data link includes information in the link that identifies (a) the query engine and (b) the data query itself. Therefore, the data-creator may be able to identify link selections made by user systems presented with query results. Thus, by aggregating interaction data from a plurality of data-creators, the analytics engine may classify data queries using the methods described below.

In a second example, the interaction data is provided by the query engine (e.g., the search engine). As described, the query engine is configured to provide query results in response to a data query generated by a user system. The query engine is also configured to track interactions between the user system and the query results that may be used to identify characteristics of data queries and classify data queries. The query engine may track the data queries it receives, the query results provided in response to each data query, and the selections made from the links presented in query results.

In a third example, a data query analytics system may track the interaction data as collected from the query engine and the data-creator and provide such interaction data to the analytics engine. In other examples, combinations of the described systems may interact to provide the interaction data to the analytics engine.

The analytics engine is also configured to identify a link selection count for each of the plurality of links based upon the plurality of interaction data. This step represents the analytics engine identifying the number of link selections made for each of the links provided in the query results produced by the query engine. As described above, data-creator targeting queries result in link selections for only links associated with the data-creator. In contrast, content targeting data queries result in a spread of link selections across data provided by a variety of data-creators. In at least some examples, this step may also involve the analytics engine “resolving” multiple links into one link when such multiple links are all associated with the same data-creator. For example, some data-creators may maintain multiple instances of link access to particular data and query engines may produce multiple links to access each of the multiple instances. To facilitate the goal of classifying data queries effectively, the analytics engine may treat such multiple links as one link because all of the links are associated with the same data-creator.

The following illustrations demonstrate the relationships between the data queries, the plurality of links, and the link selection count. Consider an example where the data query “XYZ”, when entered into a particular query engine, yields the following results:

Data Query: XYZ

Link 1: XYZ.com

Link 2: XYZZ.com

Link 3: XYZA.com

Link4: XYZB.com

In this example, the analytics engine identifies “XYZ” for analysis and retrieves interaction data between user systems and the query results from at least one of the data-creator, the query engine, and a query analytics system. The interaction data may include link selections (provided by the data-creator) that include the data query as embedded information along with the link selection. In such examples, the interaction data is processed to identify the number of link selections made for each link provided in the query results. Such processed interaction data, when aggregated to include interactions between multiple user systems and the links provided in the query results, may be presented as follows in the table below (Table 1):

TABLE 1

| | Query Result | | % of Total |
|---|---|---|---|
| Data Query | Link Identifier | Link Clicks | Clicks |
| XYZ | XYZ.com | 9,900,000 | 99% |
| XYZ | XYZZ.com | 50,000 | .5% |
| XYZ | XYZA.com | 40,000 | .4% |
| XYZ | XYZB.com | 10,000 | .1% |

In this example, the analytics engine determines that 99% of the total clicks identified in interaction data for the data query “XYZ” are associated with selections of the data-creator XYZ.com. As elaborated upon below, the analytics engine determines that the data query “XYZ” is a data-creator targeting query.

Consider a second example of the data query “car”. The data query “car”, when entered into a particular query engine, yields the following results:

Data Query: car

Link 1: car.com

Link 2: cars.com

Link 3: automobile.com

Link4: vehicles.com

In this example, the analytics engine identifies “car” for analysis and retrieves interaction data between user systems and the query results from at least one of the data-creator, the query engine, and a query analytics system. Processed interaction data, when aggregated to include interactions between multiple user systems and the links provided in the query results, may be presented as follows in the table below (Table 2):

TABLE 2

| | Query Result | | % of Total |
|---|---|---|---|
| Data Query | Link Identifier | Link Clicks | Clicks |
| car | car.com | 35,000 | 35% |
| car | cars.com | 30,000 | 30% |
| car | automobile.com | 25,000 | 25% |
| car | vehicle.com | 10,000 | 10% |

In the example of Table 2, the analytics engine determines that the link selections associated with the data query “car” are distributed across several data-creators. As elaborated upon below, the analytics engine determines that the data query “car” is not a data-creator targeting query, but rather a content-targeting query.

The analytics engine performs a classification process to classify the data query as one of a content targeting query and a data-creator targeting query based upon the plurality of link selection counts. In one example, the analytics engine applies a classification algorithm that factors in at least (a) the number of different link selections per data query (“LINK_CNT”), (b) a threshold for the number of different link selections per data query (“LINK_CNT_TH”), (c) a link selection frequency (“LINK_FQ”), and (d) a threshold for link selection frequency (“LINK_FQ_TH”). In at least one example, the algorithm may be represented as follows (Algorithm 1):

ALGORITHM 1

```
      BOOL IS_DATA-CREATOR_TARGETING;
IF (LINK_CNT<LINK_CNT_TH && LINK_FQ>LINK_FQ_TH {
      IS_DATA-CREATOR_TARGETING=TRUE;
                  } ELSE {
      IS_DATA-CREATOR_TARGETING = FALSE;
                    }
```

As described above, the number of link selections and the link selection frequency may be determined by the analytics engine (alone, or in conjunction with the query engine, the data-creator systems, and any other system) processing the interaction data describing the interaction between user systems and the query results.

The analytics engine computes the threshold for the number of different link selections per data query (represented above as “LINK_CNT_TH”). In one example, this threshold may be calculated by identifying a sample of data-creator domains with identifiers that are similar to data queries that are overtly content targeting. For example, the query “shoes” may be identified as similar to “shoes.com”, the query “rental cars” may be identified as similar to “rentalcars.com”, and the query “restaurants” may be identified as similar to “restaurants.com.” Such identification may be performed using natural-language processing algorithms or manual entry. The analytics engine then may determine the threshold based upon an average number of clicked links for the query results associated with each identified term. Using the examples above, the data query “shoes” has 6 links selected from query results, another data query “restaurants” has 7 links clicked, and the data query “car rentals” has 8 links clicked. The LINK_CNT_TH threshold will be the average of the number of selected links. Thus, in this example, the threshold is calculated by the average of: (6+7+8)/3=7. In other examples, the analytics engine may also factor the number of query results provided into the calculation of the LINK_CNT_TH. In additional examples, the LINK_CNT_TH threshold may be calculated as the minimum of the number of selected links. Thus, in such examples, the threshold may be calculated by the minimum of: min(6,7,8)=6.

The analytics engine computes the threshold for link selection frequency (“LINK_FQ_TH”). In one example, this threshold is determined by initially identifying a sample of data-creator domains with identifiers that are similar to data queries that are data-creator targeting. Such data-creator domains may be identified based on natural language processing and/or manual entry. The analytics engine then identifies link selection frequency that is exceeded by the majority of the identified data-creator domains.

As described, the analytics engine classifies the data queries. In the example embodiment, the analytics engine may classify the data queries as data-creator targeting or content targeting queries. In other embodiments, natural language processing algorithms and other data classification algorithms may be applied to assist in the identification of data-creator targeting queries are variants on the data-creator name. For example, the classification techniques described may determine that “ABC1” is a data query that identifies “ABC.com” even though the presence of the “1” suggests otherwise.

The analytics engine also may provide an analysis of the link selections (or “traffic patterns”) for each classified data query. The analysis may substantially represent a textual or graphical depiction of the frequency of selection of the data-creator's data for each reported data query. In the example embodiment, the analytics engine provides this analysis to the data-creator. In other embodiments, the analytics engine may provide this analysis to any suitable recipient system.

The analytics engine may also generate a report on data query performance for each classified data query. In one example, the analytics engine may determine that certain data queries, though popular or associated with sponsorships, may yield comparatively limited performance for a particular data-creator or data-creators.

The analytics engine may also adapt the query result for each classified data query based on the data classification. In one example, the analytics engine may determine that comparatively few links are selected from the query results. In such examples, the analytics engine may instruct the query engine to alter the query results to identify more relevant results for user systems.

The analytics engine also generates a query characteristic analysis based on the classified data queries and the plurality of link selection counts. In the example embodiment, the query characteristic analysis represents a designation of a query classification for each data query along with statistical representations of the link selections and link frequencies associated with each data query. More specifically, the query characteristic analysis may be represented by providing LINK_CNT, LINK_FQ, and classification data for a particular query in the manner indicated below (Table 3):

TABLE 3

| | | | Link |
|---|---|---|---|
| Data | | Link Selection | Frequencies |
| Query | Data | Count | Per Selection |
| QRS Cars | D-C | 1 | [100%] |
| | Targeting | | |
| Cars | Content | 10 | [20%, 10%, |
| | Targeting | | 10%, 10%, |
| | | | 10%, 10%, |
| | | | 10%, 5%, |
| | | | 3%, 2%] |

Because link frequencies are specific to each link selection, the query characteristic analysis may represent link frequencies as a vector. Thus, “Link Frequencies Per Selection” may include a vector of the same length as the value of “Link Selection Count”. In some examples, the query characteristic analysis may also include the links associated with each link of the “Link Selection Count” in an order reflected in the vector of “Link Frequencies Per Selection”. The query characteristic analysis also may be represented by any graphical depictions representing the data described above. Further, the query characteristic analysis may be applied to improve the results of query engines or to facilitate improved advertising services associated with query engines.

The methods and systems described herein may be implemented using computer programming or engineering techniques including computer software, firmware, hardware or any combination or subset thereof, wherein the technical effects may be achieved by performing one of the following steps: (a) identifying a data query for analysis from a query repository; (b) retrieving a plurality of interaction data associated with the data query, wherein the interaction data represents interactions between a plurality of user systems and a query result previously generated based on the data query, wherein the query result includes a plurality of links; (c) identifying a link selection count for each of the plurality of links based on the plurality of interaction data; (d) classifying the data query as one of a content targeting query and a data-creator targeting query based upon the plurality of link selection counts; (e) generating a query characteristic analysis based upon the classified data query and the plurality of link selection counts; (f) retrieving the plurality of interaction data from at least one of a data-creator system, a query engine, and a query analytics data repository; (g) identifying a link selection frequency based on the plurality of interaction data; (h) classifying the data query based upon the link selection count and the link selection frequency; (i) identifying a minimum interaction frequency threshold; (j) identifying the link selection count based on the plurality of interaction data for the interaction data that satisfies the minimum interaction frequency threshold; (k) identifying a minimum link selection count threshold; (l) classifying the data query based upon the link selection count and the minimum link selection count threshold; (m) providing a data-creator system with a traffic pattern analysis based upon the classified data query; (n) reporting on data query performance based upon the classified data query; and (o) adapting the query result for the data query based upon the data query classification.

Technical effects of the methods and systems described herein may include: (a) processing interaction data to identify characteristics of user system interactions with query results that are otherwise unavailable due to a lack of access to such aggregated data for other systems, (b) providing query analytics to improve query serving and query result generation; and (c) providing query analytics to improve the interaction between user systems and query engines.

Described herein are computer systems such as an analytics engine, a plurality of user systems, a query engine, and a data-creator server (or an online publication server). As described herein, all such computer systems include a processor and a memory. However, the analytics engine is specifically configured to carry out the steps described herein.

Further, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

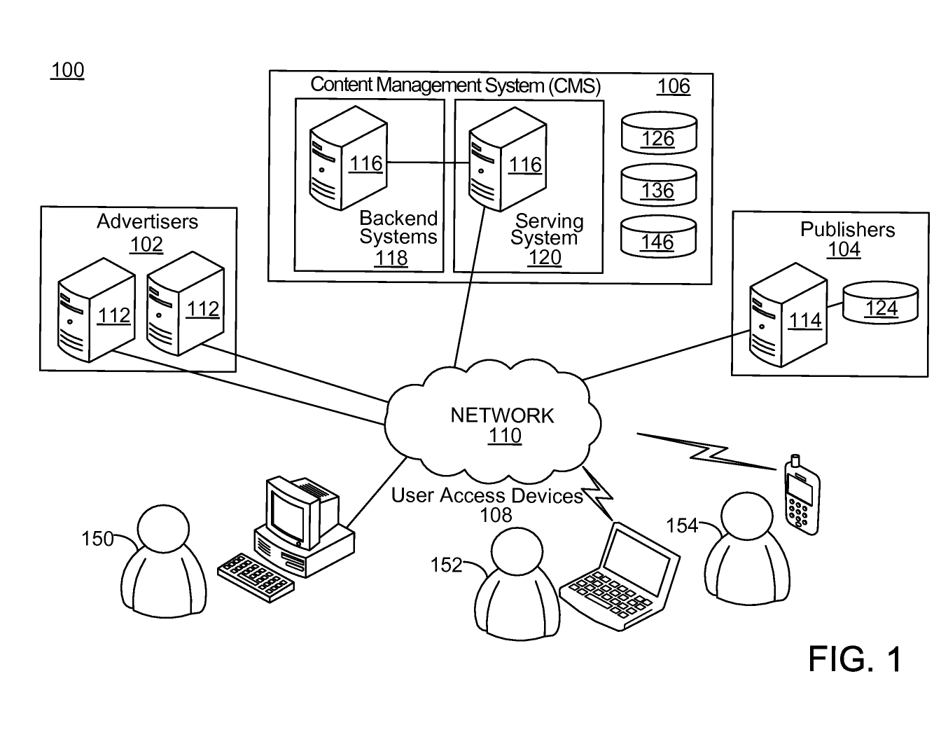

FIG. 1 is a diagram depicting an example online data environment 100. Online data environment 100 may be used in the context of serving online information to a user, including a user of a mobile computing device, in combination with online publications. With reference to FIG. 1, example environment 100 may include one or more advertisers 102 (i.e., online content providers), one or more publishers 104, a content management system (CMS) 106, and one or more user access devices 108, which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an advertisement distribution network. While reference is made to distributing advertisements, the environment 100 can be suitable for distributing other forms of content including other forms of sponsored content. CMS 106 may also be referred to as a content management system 106.

The advertisers 102 may include any entities that are associated with advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to as sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

The advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate, and/or maintain ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include any entities that generate, maintain, provide, present and/or otherwise process content in the environment 100. “Publishers,” in particular, include authors of content, wherein authors may be individual persons, or, in the case of works made for hire, the proprietor(s) who hired the individual(s) responsible for creating the online content. The term “content” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed publications, or any other form of information that may be presented to a user using a computing device such as one of user access devices 108.

In some implementations, the publishers 104 may include content providers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other content providers. One or more of the publishers 104 may represent a content network that is associated with the CMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with additional sets of content, for example ads, that are related or relevant to the retrieved content for display to users 150, 152, and 154. As discussed further below, these relevant ads may be provided from the CMS 106 and may be combined with content for display to users 150, 152, and 154. In some examples, the publishers 104 may retrieve content for display on a particular user access device 108 and then forward the content to the user access device 108 along with code that causes one or more ads from the CMS 106 to be displayed to the user 150, 152, or 154. As used herein, user access devices 108 may also be known as customer computing devices 108. In other examples, the publishers 104 may retrieve content, retrieve one or more relevant ads (e.g., from the CMS 106 or the advertisers 102), and then integrate the ads and the article to form a content page for display to the user 150, 152, or 154.

As noted above, one or more of the publishers 104 may represent a content network. In such an implementation, the advertisers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The CMS 106 manages ads and provides various services to the advertisers 102, the publishers 104, and the user access devices 108. The CMS 106 may store ads in an ad repository 126 and facilitate the distribution or selective provision and recommendation of ads through the environment 100 to the user access devices 108. In some configurations, the CMS 106 may include or access functionality associated with managing online content and/or online advertisements, particularly functionality associated with serving online content and/or online advertisements to mobile computing devices.

The CMS 106 may include one or more data processing systems 116, such as servers or embedded systems, coupled to the network 110. It can also include one or more processes, such as server processes. In some examples, the CMS 106 may include an ad serving system 120 and one or more backend processing systems 118. As described herein, ad serving system 120 may also function as a analytics engine computing device or alternately be in communication with an analytics engine computing device (not shown). The ad serving system 120 may include one or more data processing systems 116 and may perform functionality associated with delivering ads to publishers or user access devices 108. The backend processing systems 118 may include one or more data processing systems 116 and may perform functionality associated with identifying relevant ads to deliver, processing various rules, performing filtering processes, generating reports, maintaining accounts and usage information, and other backend system processing. The CMS 106 can use the backend processing systems 118 and the ad serving system 120 to selectively recommend and provide relevant ads from the advertisers 102 through the publishers 104 to the user access devices 108.

The CMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The CMS 106 may include one or more interface or frontend modules for providing the various features to advertisers, publishers, and user access devices. For example, the CMS 106 may provide one or more publisher front-end interfaces (PFEs) for allowing publishers to interact with the CMS 106. The CMS 106 may also provide one or more advertiser front-end interfaces (AFEs) for allowing advertisers to interact with the CMS 106. In some examples, the front-end interfaces may be configured as web applications that provide users with network access to features available in the CMS 106.

The CMS 106 provides various advertising management features to the advertisers 102. The CMS 106 advertising features may allow users to set up user accounts, set account preferences, create ads, select keywords for ads, create campaigns or initiatives for multiple products or businesses, view reports associated with accounts, analyze costs and return on investment, selectively identify customers in different regions, selectively recommend and provide ads to particular publishers, analyze financial information, analyze ad performance, estimate ad traffic, access keyword tools, add graphics and animations to ads, etc.

The CMS 106 may allow the advertisers 102 to create ads and input keywords or other ad placement descriptors for which those ads will appear. In some examples, the CMS 106 may provide ads to user access devices or publishers when keywords associated with those ads are included in a user request or requested content. The CMS 106 may also allow the advertisers 102 to set bids for ads. A bid may represent the maximum amount an advertiser is willing to pay for each ad impression, user click-through of an ad or other interaction with an ad. A click-through can include any action a user takes to select an ad. Other actions include haptic feedback or gyroscopic feedback to generate a click-through. The advertisers 102 may also choose a currency and monthly budget.

The CMS 106 may also allow the advertisers 102 to view information about ad impressions, which may be maintained by the CMS 106. The CMS 106 may be configured to determine and maintain the number of ad impressions relative to a particular website or keyword. The CMS 106 may also determine and maintain the number of click-throughs for an ad as well as the ratio of click-throughs to impressions.

The CMS 106 may also allow the advertisers 102 to select and/or create conversion types for ads. A “conversion” may occur when a user consummates a transaction related to a given ad. A conversion could be defined to occur when a user clicks, directly or implicitly (e.g., through haptic or gyroscopic feedback), on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The CMS 106 may store conversion data and other information in a conversion data repository 136.

The CMS 106 may allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The CMS 106 may provide various features to the publishers 104. The CMS 106 may deliver ads (associated with the advertisers 102) to the user access devices 108 when users access content from the publishers 104. The CMS 106 can be configured to deliver ads that are relevant to publisher sites, site content, and publisher audiences.

In some examples, the CMS 106 may crawl content provided by the publishers 104 and deliver ads that are relevant to publisher sites, site content and publisher audiences based on the crawled content. The CMS 106 may also selectively recommend and/or provide ads based on user information and behavior, such as particular search queries performed on a search engine website, or a designation of an ad for subsequent review, as described herein, etc. The CMS 106 may store user-related information in a general database 146. In some examples, the CMS 106 can add search services to a publisher site and deliver ads configured to provide appropriate and relevant content relative to search results generated by requests from visitors of the publisher site. A combination of these and other approaches can be used to deliver relevant ads.

The CMS 106 may allow the publishers 104 to search and select specific products and services as well as associated ads to be displayed with content provided by the publishers 104. For example, the publishers 104 may search through ads in the ad repository 126 and select certain ads for display with their content.

The CMS 106 may be configured to selectively recommend and provide ads created by the advertisers 102 to the user access devices 108 directly or through the publishers 104. The CMS 106 may selectively recommend and provide ads to a particular publisher 104 (as described in further detail herein) or a requesting user access device 108 when a user requests search results or loads content from the publisher 104.

In some implementations, the CMS 106 may manage and process financial transactions among and between elements in the environment 100. For example, the CMS 106 may credit accounts associated with the publishers 104 and debit accounts of the advertisers 102. These and other transactions may be based on conversion data, impressions information and/or click-through rates received and maintained by the CMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed advertisers 102, publishers 104 and/or user access devices 108, which may be discrete, integrated modules or distributed systems. Similarly, the environment 100 is not limited to a single CMS 106 and may include any number of integrated or distributed CMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

The CMS 106 may also be configured to provide, directly or indirectly, query engine functionality (or search engine functionality) that may enable users to identify content from publishers 104 based upon a submission of such search queries to CMS 106. In an example embodiment, user access devices 108 submit data queries (not shown in FIG. 1) to CMS 106 which then identifies query results reflecting identifiers and links of content available from publishers 104. Accordingly, CMS 106 may facilitate providing such query or search engine functionality. In other embodiments, CMS 106 may interact with a secondary query engine server to provide such functionality.

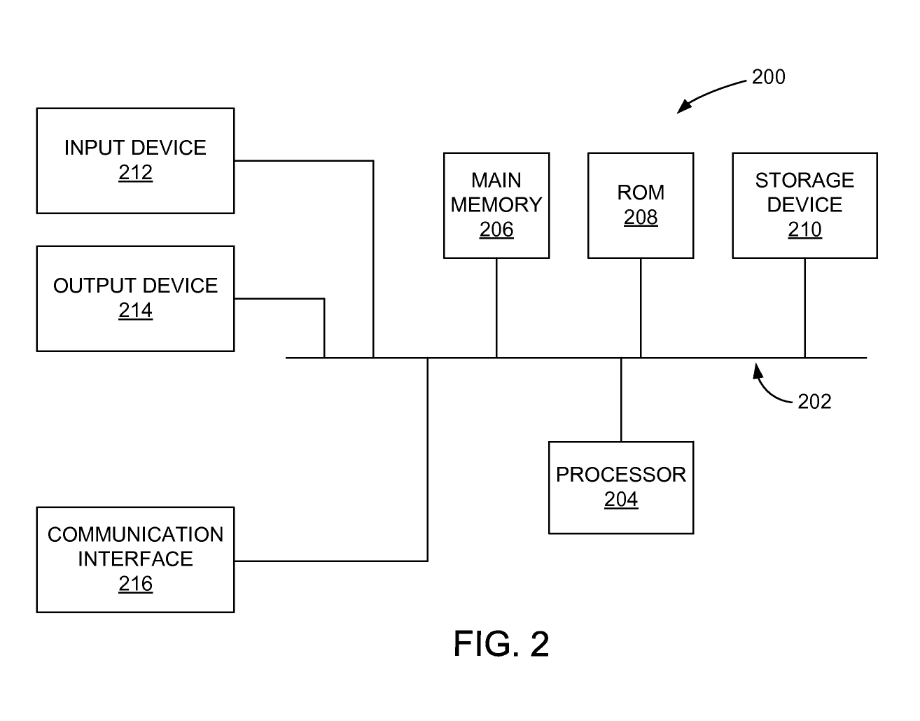

FIG. 2 is a block diagram of a computing device, used for determining analytic relationships in data queries based on responsive data sets, as shown in the online data environment of FIG. 1.

FIG. 2 shows an example of a special-purpose computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others.

Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

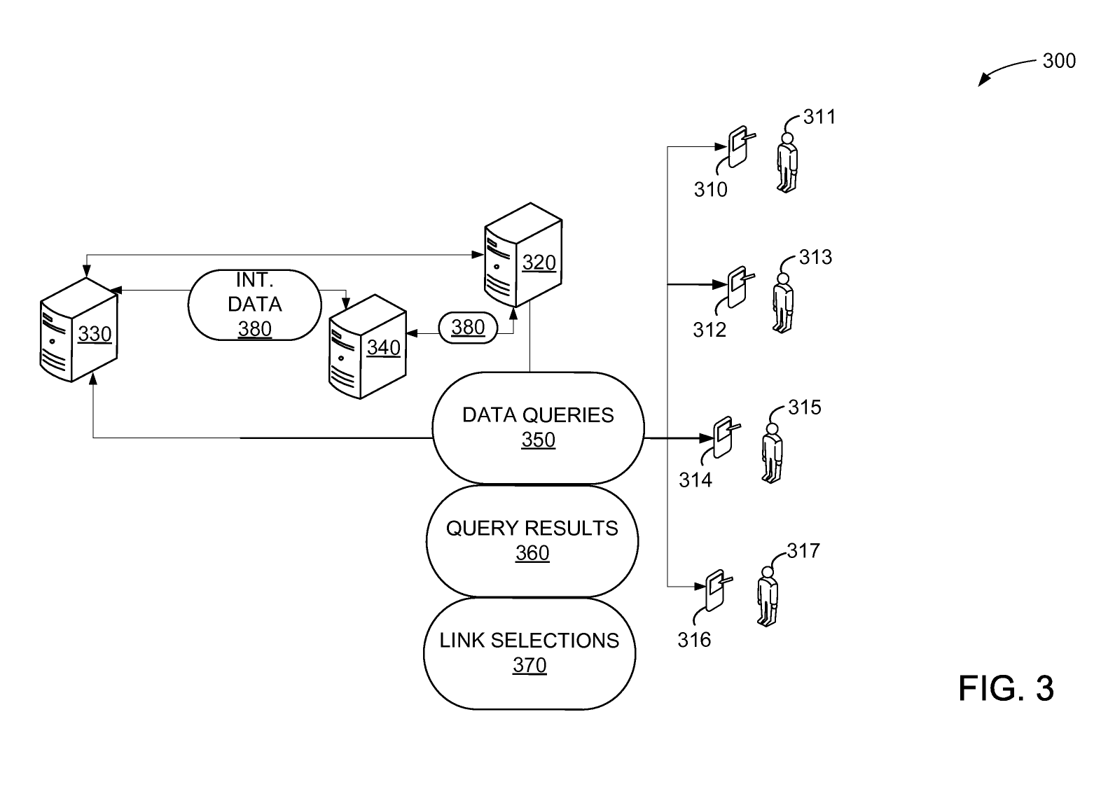

FIG. 3 is an example data flowchart of determining analytic relationships in data queries based on responsive data sets using the computing device of FIG. 2 in the online data environment shown in FIG. 1.

In the example embodiment, a plurality of users 311, 313, 315, and 317 (i.e., a plurality of online users) uses user computing devices 310, 312, 314, and 316 to interact with data from a plurality of data-creators 330. More specifically, user computing devices 310, 312, 314, and 316 transmit a plurality of data queries 350 to query engine 320 and receive query results 360 in response. User computing devices 310, 312, 314, and 316 make link selections 370 from query results 360 and access data from one of data-creators 330. As described above, analytics engine 340 receives interaction data 380 representing the exchanges 350, 360, and 370 made between user computing devices 310, 312, 314, and 316 and query engine 320. Analytics engine 340 performs the classification processes described above and herein using such interaction data 380.

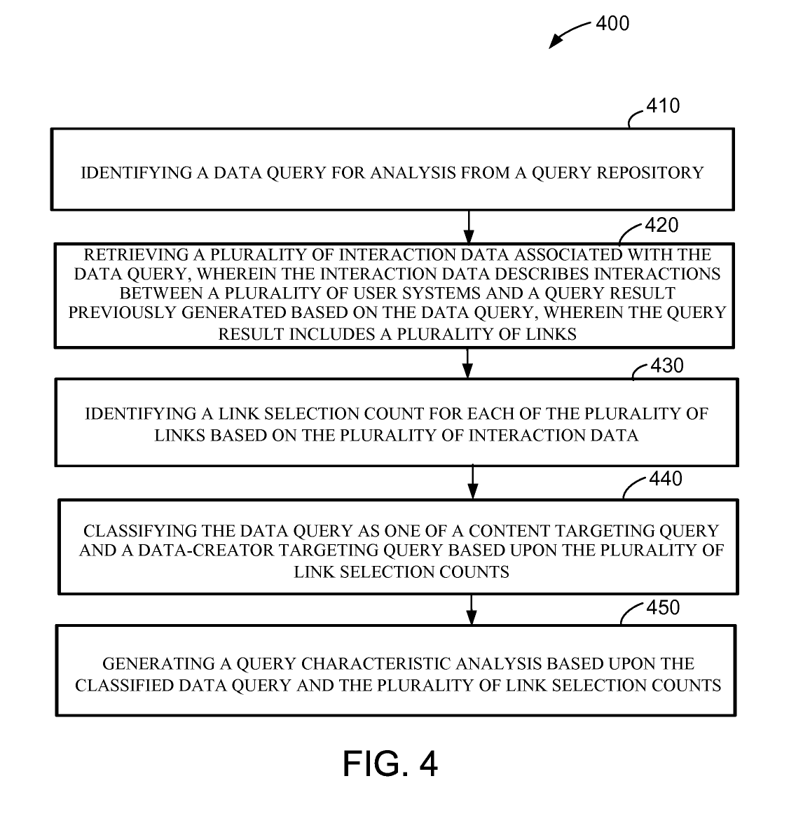

FIG. 4 is an example method of determining analytic relationships in data queries based on responsive data sets using the online data environment of FIG. 1. Method 400 is performed by analytics engine computing device 340 (shown in FIG. 3).

Analytics engine 340 is configured to identify 410 a data query for analysis from a query repository, retrieve 420 a plurality of interaction data associated with the data query, wherein the interaction data represents interactions between a plurality of user systems and a query result previously generated based on the data query, wherein the query result includes a plurality of links, identify 430 a link selection count for each of the plurality of links based on the plurality of interaction data, classify 440 the data query as one of a content targeting query and a data-creator targeting query based upon the plurality of link selection counts, and generate 450 a query characteristic analysis based upon the classified data query and the plurality of link selection counts.

Analytics engine 340 is configured to identify 410 data queries 350 (shown in FIG. 3) for analysis from a query repository available in any system 320, 330, and 340 (all shown in FIG. 3). The query repository may be generated on demand, identified manually, or previously generated based upon analysis of data queries 350 captured by the systems 320, 330, and 340 including the analytics engine 340, the data-creator systems 330, and the query engine systems 320. In many examples, the analytics engine 340 may process multiple data queries 350 simultaneously and therefore classify multiple data queries 350 simultaneously.

Analytics engine 340 is also configured to retrieve a plurality of interaction data 380 (shown in FIG. 3) associated with the identified data query 350. The interaction data 380 represents (or describes) interactions between a plurality of user systems 310, 312, 314, and 316 (all shown in FIG. 3) and a query result 360 (shown in FIG. 3) previously generated based on the data query 350. The query result 360 includes a plurality of links and may also include descriptive information describing the data available based upon a selection of a link.

As described below, the interaction data 380 may be provided in a variety of formats. In a first example, the interaction data 380 is provided by the data-creator 330 or publisher. For example, the data-creator 330 may collect directly, or through an intermediary, interaction data 380 generated by user systems 310, 312, 314, and 316 accessing their data (e.g., visiting a website associated with the data-creator 330). In one example, the collected interaction data may include information that is passed as part of the request URL to fetch the data. For example, a query engine 320 (e.g., a search engine) may produce query results 360 with a plurality of data links such that each data link includes information in the link that identifies (a) the query engine 320 and (b) the data query 350 itself. Therefore, the data-creator 330 may be able to identify link selections 370 made by user systems 310, 312, 314, and 316 presented with query results 360. Thus, by aggregating interaction data 380 from a plurality of data-creators 330, the analytics engine 340 may classify data queries 350 using the methods described below.

In a second example, the interaction data 380 is provided by the query engine 320 (e.g., the search engine). As described, the query engine 320 is configured to provide query results 360 in response to a data query 350 generated by a user system 310, 312, 314, and 316. The query engine 320 is also configured to track interactions between the user systems 310, 312, 314, and 316 and the query results 360 that may be used to identify characteristics of data queries 350 and classify data queries 350. The query engine 320 may track the data queries 350 it receives, the query results 360 provided in response to each data query 350, and the link selections 370 made from the links presented in query results 360.

In a third example, a data query analytics system (not shown) may track the interaction data 380 as collected from the query engine 320 and/or the data-creator 330 and provide such interaction data 380 to the analytics engine 340. In other examples, combinations of the described systems 320, 330, and 340 may interact to provide the interaction data 380 to the analytics engine 340.

The analytics engine 340 is also configured to identify a link selection count for each of the plurality of links based upon the plurality of interaction data 380. This step represents the analytics engine 340 identifying the number of link selections made for each of the links provided in the query results 360 produced by the query engine 320. As described above, data-creator targeting queries result in link selections 370 for only links associated with a particular data-creator 330. In contrast, content targeting data queries result in a spread of link selections 370 across data provided by a variety of data-creators 330. In at least some examples, this step may also involve the analytics engine 340 “resolving” multiple links into one link when such multiple links are all associated with the same data-creator 330. For example, some data-creators 330 may maintain multiple instances of link access to particular data and query engines 320 may produce multiple links to access each of the multiple instances. To facilitate the goal of classifying data queries 350 effectively, the analytics engine 340 may treat such multiple links as one link because all of the links are associated with the same data-creator 330.

The following illustrations demonstrate the relationships between the data queries 350, the plurality of links, and the link selection count. Consider an example where the data query 350 of “XYZ”, when entered into a particular query engine 320, yields the following results:

Data Query: XYZ

Link 1: XYZ.com

Link 2: XYZZ.com

Link 3: XYZA.com

Link4: XYZB.com

In this example, the analytics engine 340 identifies “XYZ” for analysis and retrieves interaction data 380 between user systems 310, 312, 314, and 316 and the query results 360 from at least one of the data-creator 330, the query engine 320, and a query analytics system (not shown). The interaction data 380 may include link selections 370 (provided by the data-creator 330) that include the data query 350 as embedded information along with the link selection 370. In such examples, the interaction data 380 is processed to identify the number of link selections 370 made for each link provided in the query results 360. Such processed interaction data 380, when aggregated to include interactions between multiple user systems 310, 312, 314, and 316 and the links provided in the query results 360, may be presented as follows in the table below (Table 1):

TABLE 1

| | Query Result | | % of Total |
|---|---|---|---|
| Data Query | Link Identifier | Link Clicks | Clicks |
| XYZ | XYZ.com | 9,900,000 | 99% |
| XYZ | XYZZ.com | 50,000 | .5% |
| XYZ | XYZA.com | 40,000 | .4% |
| XYZ | XYZB.com | 10,000 | .1% |

In this example, the analytics engine 340 determines that 99% of the total clicks identified in interaction data 380 for the data query 350 of “XYZ” are associated with selections of the data-creator 330 of XYZ.com. As elaborated upon below, the analytics engine 340 determines that the data query 350 of “XYZ” is a data-creator targeting query.

Consider a second example of the data query 350 of “car”. The data query 350 of “car”, when entered into a particular query engine 320, yields the following results:

Data Query: car

Link 1: car.com

Link 2: cars.com

Link 3: automobile.com

Link4: vehicles.com

In this example, the analytics engine 340 identifies “car” for analysis and retrieves interaction data 380 between user systems 310, 312, 314, and 316 and the query results 360 from at least one of the data-creator 330, the query engine 320, and a query analytics system (not shown). Processed interaction data 380, when aggregated to include interactions between multiple user systems 310, 312, 314, and 316 and the links provided in the query results 360, may be presented as follows in the table below (Table 2):

TABLE 2

| | Query Result | | % of Total |
|---|---|---|---|
| Data Query | Link Identifier | Link Clicks | Clicks |
| car | car.com | 35,000 | 35% |
| car | cars.com | 30,000 | 30% |
| car | automobile.com | 25,000 | 25% |
| car | vehicle.com | 10,000 | 10% |

In the example of Table 2, the analytics engine 340 determines that the link selections 370 associated with the data query 350 of “car” are distributed across several data-creators 330. As elaborated upon below, the analytics engine 340 determines that the data query 350 of “car” is not a data-creator targeting query, but rather a content-targeting query.

The analytics engine 340 performs a classification process to classify the data query 350 as one of a content targeting query and a data-creator targeting query based upon the plurality of link selection counts. In one example, the analytics engine 340 applies a classification algorithm that factors in at least (a) the number of different link selections per data query (“LINK_CNT”), (b) a threshold for the number of different link selections per data query (“LINK_CNT_TH”), (c) a link selection frequency (“LINK_FQ”), and (d) a threshold for link selection frequency (“LINK_FQ_TH”). In at least one example, the algorithm may be represented as follows (Algorithm 1):

ALGORITHM 1

```
      BOOL IS_DATA-CREATOR_TARGETING;
IF (LINK_CNT<LINK_CNT_TH && LINK_FQ>LINK_FQ_TH {
      IS_DATA-CREATOR_TARGETING=TRUE;
                    } ELSE {
      IS_DATA-CREATOR_TARGETING = FALSE;
                      }
```

As described above, the number of link selections 370 and the link selection frequency may be determined by the analytics engine (alone, or in conjunction with the query engine, the data-creator systems, and any other system) processing the interaction data 380 describing the interaction between user systems 310, 312, 314, and 316 and the query results 360.

The analytics engine 340 computes the threshold for the number of different link selections per data query (represented above as “LINK_CNT_TH”). In one example, this threshold may be calculated by identifying a sample of data-creator domains with identifiers that are similar to data queries that are overtly content targeting. For example, the query “shoes” may be identified as similar to “shoes.com”, the query “rental cars” may be identified as similar to “rentalcars.com”, and the query “restaurants” may be identified as similar to “restaurants.com.” Such identification may be performed using natural-language processing algorithms or manual entry. The analytics engine 340 then may determine the threshold based upon an average number of clicked links for the query results associated with each identified term. Using the examples above, the data query “shoes” has 6 links selected from query results, another data query “restaurants” has 7 links clicked, and the data query “car rentals” has 8 links clicked. The LINK_CNT_TH threshold will be the average of the number of selected links. Thus, in this example, the threshold is calculated by the average of: (6+7+8)/3=7. In other examples, the analytics engine 340 may also factor the number of query results provided into the calculation of the LINK_CNT_TH. In additional examples, the LINK_CNT_TH threshold may be calculated as the minimum of the number of selected links. Thus, in such examples, the threshold may be calculated by the minimum of: min(6,7,8)=6.

The analytics engine 340 computes the threshold for link selection frequency (“LINK_FQ_TH”). In one example, this threshold is determined by initially identifying a sample of data-creator domains with identifiers that are similar to data queries that are data-creator targeting. Such data-creator domains may be identified based on natural language processing and/or manual entry. The analytics engine 340 then identifies link selection frequency that is exceeded by the majority of the identified data-creator domains.

As described, the analytics engine classifies the data queries. In the example embodiment, the analytics engine may classify the data queries as data-creator targeting or content targeting queries. In other embodiments, natural language processing algorithms and other data classification algorithms may be applied to assist in the identification of data-creator targeting queries are variants on the data-creator name. For example, the classification techniques described may determine that “ABC1” is a data query that identifies “ABC.com” even though the presence of the “1” suggests otherwise.

The analytics engine 340 also may provide an analysis of the link selections (or “traffic patterns”) for each classified data query 350. The analysis may substantially represent a textual or graphical depiction of the frequency of selection of the data-creator's data for each reported data query. In the example embodiment, the analytics engine 340 provides this analysis to the data-creator 330. In other embodiments, the analytics engine 340 may provide this analysis to any suitable recipient system.

The analytics engine 340 may also generate a report on data query performance for each classified data query 350. In one example, the analytics engine 340 may determine that certain data queries 350, though popular or associated with sponsorships, may yield comparatively limited performance for a particular data-creator 330 or data-creators 330.

The analytics engine 340 may also adapt the query result 360 for each classified data query 350 based on the data classification. In one example, the analytics engine 340 may determine that comparatively few links are selected from the query results 360. In such examples, the analytics engine 340 may instruct the query engine 320 to alter the query results 360 to identify more relevant results for user systems 310, 312, 314, and 316.

The analytics engine 340 also generates a query characteristic analysis based on the classified data queries and the plurality of link selection counts. In the example embodiment, the query characteristic analysis represents a designation of a query classification for each data query along with statistical representations of the link selections and link frequencies associated with each data query.

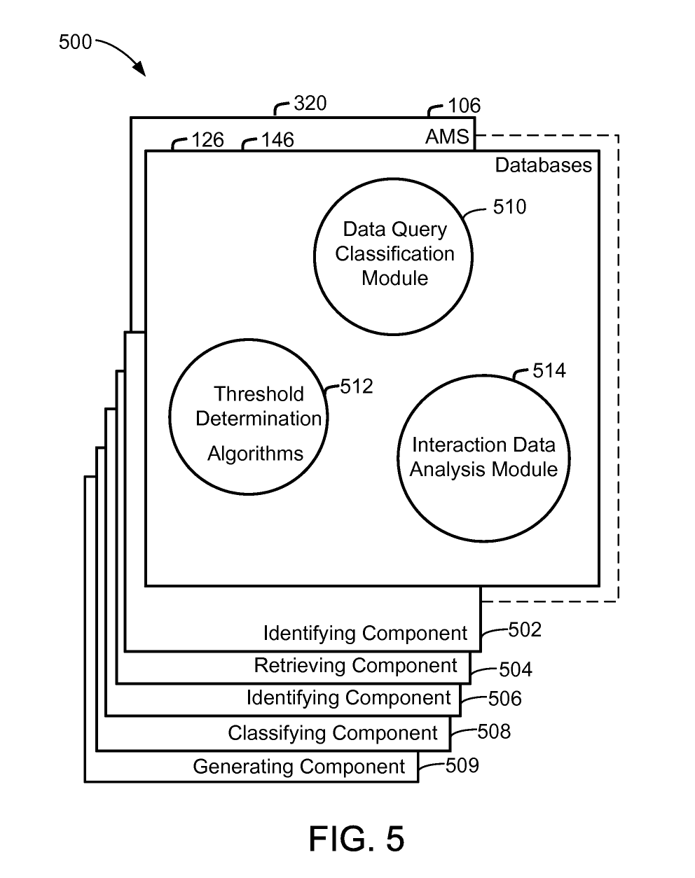

FIG. 5 is a diagram of components of one or more example computing devices, for determining analytic relationships in data queries based on responsive data sets using the online data environment that may be used in the environment shown in FIG. 1.

For example, one or more of computing devices 200 may form content management system (CMS) 106, customer computing device 108 (both shown in FIG. 1), user systems, search engines, and online publication systems, and analytics engine 340. FIG. 5 further shows a configuration of databases 126 and 146 (shown in FIG. 1). Databases 126 and 146 are coupled to several separate components within analytics engine 340, content provider data processing system 112, and customer computing device 108, which perform specific tasks.

Analytics engine 340 includes a first identifying component 502 for identifying a data query for analysis from a query repository. Analytics engine 340 additionally includes a first retrieving component 504 for retrieving a plurality of interaction data associated with the data query, wherein the interaction data represents interactions between a plurality of user systems and a query result previously generated based on the data query, wherein the query result includes a plurality of links. Analytics engine 340 further includes a second identifying component 506 for identifying a link selection count for each of the plurality of links based on the plurality of interaction data. Analytics engine 340 also includes a classifying component 508 for classifying the data query as one of a content targeting query and a data-creator targeting query based upon the plurality of link selection counts. Analytics engine 340 additionally includes a generating component 509 for generating a query characteristic analysis based upon the classified data query and the plurality of link selection counts.

In an exemplary embodiment, databases 126 and 146 are divided into a plurality of sections, including but not limited to, a data query classification module 510, threshold determination algorithms 512, and an interaction data analysis module 514. These sections within database 126 and 146 are interconnected to update and retrieve the information as required.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the subject matter described herein or its features may have different names, formats, or protocols. Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for determining analytic relationships in data queries based on responsive data sets, the method implemented using an analytics engine coupled to a memory device, the method comprising:
identifying a data query for analysis from a query repository;
retrieving a plurality of interaction data associated with the data query, wherein the interaction data represents interactions between a plurality of user systems and a query result previously generated based on the data query, wherein the query result includes a plurality of links;
identifying a link selection count for each of the plurality of links based on the plurality of interaction data;
classifying the data query as one of a content targeting query and a data-creator targeting query based upon the plurality of link selection counts; and
generating a query characteristic analysis based upon the classified data query and the plurality of link selection counts.

2. The method of claim 1, further comprising:
retrieving the plurality of interaction data from at least one of a data-creator system, a query engine, and a query analytics system.

3. The method of claim 1, further comprising:
identifying a link selection frequency based on the plurality of interaction data; and
classifying the data query based upon the link selection count and the link selection frequency.

4. The method of claim 1, further comprising:
identifying a minimum interaction frequency threshold; and
identifying the link selection count based on the plurality of interaction data for the interaction data that satisfies the minimum interaction frequency threshold.

5. The method of claim 1, further comprising:
identifying a minimum link selection count threshold; and
classifying the data query based upon the link selection count and the minimum link selection count threshold.

6. The method of claim 1, further comprising:
providing, to a data-creator system, a traffic pattern analysis based upon the classified data query.

7. The method of claim 1, further comprising:
reporting on data query performance based upon the classified data query.

8. The method of claim 1, further comprising:
adapting the query result for the data query based upon the data query classification.

9. An analytics engine for determining analytic relationships in data queries based on responsive data sets, the analytics engine comprising a memory for storing data, and a processor in communication with the memory, said processor programmed to:
identify a data query for analysis from a query repository;
retrieve a plurality of interaction data associated with the data query, wherein the interaction data represents interactions between a plurality of user systems and a query result previously generated based on the data query, wherein the query result includes a plurality of links;
identify a link selection count for each of the plurality of links based on the plurality of interaction data;
classify the data query as one of a content targeting query and a data-creator targeting query based upon the plurality of link selection counts; and
generate a query characteristic analysis based upon the classified data query and the plurality of link selection counts.

10. The analytics engine of claim 9, wherein the processor is further programmed to:
retrieve the plurality of interaction data from at least one of a data-creator system, a query engine, and a query analytics system.

11. The analytics engine of claim 9, wherein the processor is further programmed to:
identify a link selection frequency based on the plurality of interaction data; and
classify the data query based upon the link selection count and the link selection frequency.

12. The analytics engine of claim 9, wherein the processor is further programmed to:
identify a minimum interaction frequency threshold; and
identify the link selection count based on the plurality of interaction data for the interaction data that satisfies the minimum interaction frequency threshold.

13. The analytics engine of claim 9, wherein the processor is further programmed to:
identify a minimum link selection count threshold; and
classify the data query based upon the link selection count and the minimum link selection count threshold.

14. The analytics engine of claim 9, wherein the processor is further programmed to:
provide, to a data-creator system, a traffic pattern analysis based upon the classified data query.

15. The analytics engine of claim 9, wherein the processor is further programmed to:
report on data query performance based upon the classified data query.

16. The analytics engine of claim 9, wherein the processor is further programmed to:
adapt the query result for the data query based upon the data query classification.

17. A computer-readable storage device, having processor-executable instructions embodied thereon, for determining analytic relationships in data queries based on responsive data sets, wherein the computer includes at least one processor and a memory coupled to the processor, wherein, when executed by the computer, the processor-executable instructions cause the computer to:
identify a data query for analysis from a query repository;
retrieve a plurality of interaction data associated with the data query, wherein the interaction data represents interactions between a plurality of user systems and a query result previously generated based on the data query, wherein the query result includes a plurality of links;
identify a link selection count for each of the plurality of links based on the plurality of interaction data;
classify the data query as one of a content targeting query and a data-creator targeting query based upon the plurality of link selection counts; and
generate a query characteristic analysis based upon the classified data query and the plurality of link selection counts.

18. The computer-readable storage device of claim 17, wherein the processor-executable instructions cause the computing device to:
retrieve the plurality of interaction data from at least one of a data-creator system, a query engine, and a query analytics system.

19. The computer-readable storage device of claim 17, wherein the processor-executable instructions cause the computing device to:
identify a link selection frequency based on the plurality of interaction data; and
classify the data query based upon the link selection count and the link selection frequency.

20. The computer-readable storage device of claim 17, wherein the processor-executable instructions cause the computing device to:
identify a minimum interaction frequency threshold; and
identify the link selection count based on the plurality of interaction data for the interaction data that satisfies the minimum interaction frequency threshold.

21. The computer-readable storage device of claim 17, wherein the processor-executable instructions cause the computing device to:
identify a minimum link selection count threshold; and
classify the data query based upon the link selection count and the minimum link selection count threshold.

22. The computer-readable storage device of claim 17, wherein the processor-executable instructions cause the computing device to:
provide, to a data-creator system, a traffic pattern analysis based upon the classified data query.

23. The computer-readable storage device of claim 17, wherein the processor-executable instructions cause the computing device to:
report on data query performance based upon the classified data query.

24. The computer-readable storage device of claim 17, wherein the processor-executable instructions cause the computing device to:
adapt the query result for the data query based upon the data query classification.
